(19) United States
(12) Patent Application Publication
(10) Pub. No.: US 2012/0069723 A1
(43) Pub. Date: Mar. 22, 2012

(54) OPTICAL RECORDING MEDIUM DRIVE DEVICE AND RECORDING METHOD

(75) Inventors: Makoto Sato, Tokorozawa (JP); Masakazu Ogasawara, Higashimatsuyama (JP); Kazuo Takahashi, Hanno (JP); Masaharu Nakano, Kawasaki (JP)

(73) Assignee: PIONEER CORPORATION, Meguro-ku, Tokyo (JP)

(21) Appl. No.: 13/265,684

(22) PCT Filed: Apr. 24, 2009
(86) PCT No.: PCT/JP2009/058140

§ 371 Date: Dec. 8, 2011

(51) Int. Cl. G11B 7/00

(52) U.S. Cl. 369/44.32; G9B/7

(57) ABSTRACT

An optical recording medium drive device including: a combining prism for combining a recording first laser beam emitted from a first light source with a recording second laser beam emitted from the first light source so as to coaxially guide them; an objective lens for condensing the first and second laser beams from the combining prism toward an optical recording medium; a first photodetecting means for detecting reflected light of the first laser beam from a recording layer; a second photodetecting means for detecting reflected light of the second laser beam from a guide layer; a magnification conversion element disposed on an optical path of the second laser beam between a second light source and the combining prism for diffusing or converging the second laser beam incident upon the objective lens; a first focus error generating means for generating a first focus error signal indicating an error between a condensed spot position of the first laser beam and the recording layer based on an output signal of the first photodetecting means; a second focus error generating means for generating a second focus error signal indicating an error between a condensed spot position of the second laser beam and the guide layer based on an output signal of the second photodetecting means; a first focus control means for controlling the objective lens in an optical axis direction thereof in accordance with the first focus error signal; and a second focus control means for controlling a magnitude of the diffusion or convergence of the second laser beam by the magnification conversion element in accordance with the second focus error signal.

### TECHNICAL FIELD

The present invention relates to a drive device and a recording method for a separated guide layer type optical recording medium.

### BACKGROUND ART

As an optical disk having a number of recording layers, there is a separated guide layer type disk in which the recording layers are formed separately from a guide layer. An optical disk drive device for recording or reproducing information to or from the separated guide layer type disk requires a guide laser beam (guide light) for reading out information on a guide track from the guide layer, and a recording or reproducing laser beam (recording/reproducing light) for writing information to a recording layer or reading out the recorded information from the recording layer. Therefore, an optical disk recording/reproducing device includes an optical guide system which irradiates the guide layer of the optical disk with the guide laser beam and receives the reflected light, and an optical recording/reproducing system which irradiates any one of the recording layers of the optical disk with the recording/reproducing laser beam and receives the reflected light. In the optical guide system and the optical recording/reproducing system, one objective lens is shared.

In a conventional optical disk drive device, when recording information to one recording layer, while a focal point position of a guide laser beam is moved on a guide track of a guide layer by focus servo control and tracking servo control for driving an objective lens, a collimator lens of an optical recording/reproducing system is moved in an optical axis direction to condense a recording/reproducing laser beam on one recording layer, thereby writing information thereto (see Patent Literature 1). As another method, while a focal point position of a guide laser beam is moved on a guide track of a guide layer by focus servo control and tracking servo control for driving an objective lens, a collimator lens of an optical guide system is moved in an optical axis direction to change a distance (working distance WD) between an optical disk and the objective lens. As a result, a focal point position recording/reproducing laser beam is condensed onto one recording layer while maintaining a focus state of the guide laser beam, thereby writing information thereto (see Patent Literature 2).

### CITATION LIST

### Patent Literature

Patent Literature 1: Japanese Patent No. 4037034
Patent Literature 2: Japanese Patent No. 3455144

### DISCLOSURE OF INVENTION

### Technical Problem

In a conventional optical disk drive device compliant with a separated guide layer type disk, however, since focus servo control of the recording/reproducing light to a recording layer is performed by moving the collimator lens provided in the optical recording/reproducing system or the optical guide system in the optical axis direction to change a diffusion level of the recording/reproducing light incident upon the objective lens, there has been a problem that there lacks an accuracy or a stability in focus servo control of the recording/reproducing light to the recording layer when recording information. Particularly when there is a destabilizing factor such as disturbance or surface runout of an optical disk, the objective lens itself, which is driven by the focus servo control of the guide light, moves in an unpredictable manner in the optical axis direction. Due to such an unpredictable movement of the objective lens, a condensed spot position of the recording/reproducing light adversely affects the accuracy or stability in the focus servo control of the recording/reproducing light to the recording layer.

Thus, problems to be solved by the present invention include the above-described disadvantage as an example, and an object of the present invention is to provide an optical recording medium drive device and a recording method capable of recording information by condensing recording light onto a target recording layer while making guide light perform tracking of a guide track in a guide layer accurately and stably when recording to a separated guide layer type optical recording medium.

### Solution to Problem

An optical recording medium drive device of an invention according to claim 1 is an optical recording medium drive device for optically recording information in accordance with a guide track to a recording layer of a separated guide layer type optical recording medium in which a guide layer having the guide track formed thereon and the recording layer are layered so as to be spaced apart from each other, including: a first light source for generating a recording first laser beam; a second light source for generating a guide second laser beam; a combining prism for combining the first laser beam with the second laser beam so as to coaxially guide them; an objective lens for condensing the respective first and second laser beams from the combining prism toward the optical recording medium; first photodetecting means for detecting reflected light of the first laser beam from the recording layer; second photodetecting means for detecting reflected light of the second laser beam from the guide layer; a magnification conversion element disposed on an optical path of the second laser beam between the second light source and the combining prism for diffusing or converging the second laser beam incident upon the objective lens; first focus error generating means for generating a first focus error signal indicating an error between a condensed spot position of the first laser beam and the recording layer based on an output signal of the first photodetecting means; second focus error generating means for generating a second focus error signal indicating an error between a condensed spot position of the second laser beam and the guide layer based on an output signal of the second photodetecting means; first focus control means for controlling the objective lens in an optical axis direction thereof in accordance with the first focus error signal; and a second focus control means for controlling a magnitude of the diffusion or convergence of the second laser beam by the magnification conversion element in accordance with the second focus error signal.

A recording method of an optical recording medium drive device of an invention according to claim 11 is a recording method of an optical recording medium drive device which includes, for optically recording information in accordance with a guide track to a recording layer of a separated guide layer type optical recording medium in which a guide layer having the guide track formed thereon and the recording layer are layered so as to be spaced apart from each other: a first light source for generating a recording first laser beam; a second light source for generating a guide second laser beam; a combining prism for combining the first laser beam with the second laser beam so as to coaxially guide them; an objective lens for condensing the respective first and second laser beams from the combining prism toward the optical recording medium; first photodetecting means for detecting reflected light of the first laser beam from the recording layer; second photodetecting means for detecting reflected light of the second laser beam from the guide layer; a magnification conversion element disposed on an optical path of the second laser beam between the second light source and the combining prism for diffusing or converging the second laser beam incident upon the objective lens; and a spherical aberration correcting element disposed on an optical path of the first laser beam between the first light source and the combining prism. In the method, the spherical aberration correcting element is controlled to be in a correction state optimum for reproduction of the recording layer; the objective lens is controlled in accordance with the first focus error signal so that a focal point of the first laser beam is positioned on the recording layer; the magnification conversion element is controlled in accordance with a second focus error signal so that a focal point of the second laser beam is positioned on the guide layer; the objective lens is controlled in accordance with the tracking error signal so that a condensed spot position of the second laser beam is positioned on the guide track of the guide layer; recording medium information is read out based on an output signal of the second photodetecting means; and the first laser beam is modulated to start recording to the recording layer.

### DESCRIPTION OF EMBODIMENTS

According to the optical recording medium drive device of the invention of claim 1 and the recording method of the invention of claim 11, the objective lens is controlled in the optical axis direction thereof in accordance with the first focus error signal indicating an error between the condensed spot position of the first laser beam and the recording layer of the optical recording medium and a magnitude of the diffusion or convergence of the second laser beam by the magnification conversion element is controlled in accordance with the second focus error signal indicating an error between the condensed spot position of the second laser beam and the guide layer of the optical recording medium, thereby condensing the first laser beam on the recording layer and condensing the second laser beam on the guide layer. Thus, when recording to a separated guide layer type optical recording medium, information can be recorded by condensing the recording light on a target recording layer while accurately and stably making the guide light perform tracking of the guide track in the guide layer.

### BRIEF DESCRIPTION OF DRAWINGS

FIG. 1 is a diagram showing a configuration of an optical disk drive device as an embodiment of the present invention.

FIG. 2 is a diagram showing an aperture diameter of an aperture limiting element.

FIG. 3 is a diagram showing transmittances for wavelengths of the aperture limiting element.

FIG. 4 is a flow chart showing a recording operation of the device in FIG. 1.

FIG. 5 is a diagram illustrating a focal point position of recording/reproducing light resulted from a movement of an objective lens and a focal point position resulted from a movement of a correcting lens of a magnification conversion element.

FIG. 6 is a flow chart showing another recording operation of the device in FIG. 1.

FIG. 7 is a flow chart showing another recording operation of the device in FIG. 1.

FIG. 8 is a diagram showing a configuration of an optical disk drive device as another embodiment of the present invention.

FIG. 9 is a flow chart showing a recording operation of the device in FIG. 8.

FIG. 10 is a diagram showing a configuration of an optical disk drive device as another embodiment of the present invention.

FIG. 11 is a flow chart showing a recording operation of the device in FIG. 10.

FIG. 12 is a graph showing intensities of a recording/reproducing focus error signal depending on moved positions of a correcting lens of a spherical aberration correcting element.

FIG. 13 is a graph showing intensities of a guide focus error signal depending on moved positions of a correcting lens of a magnification conversion element.

### EMBODIMENTS

Hereinafter, embodiments of the present invention will be described in detail with reference to the drawings.

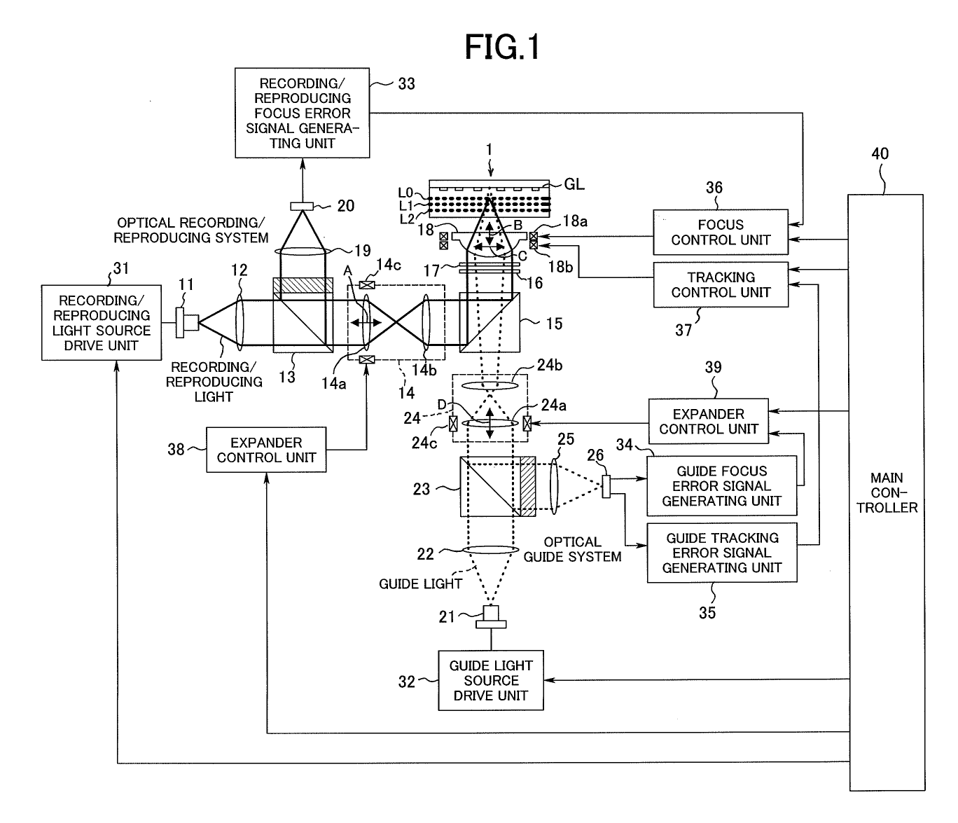

FIG. 1 shows a configuration of a multilayer optical disk recording/reproducing device to which the present invention is applied. This multilayer optical disk recording/reproducing device is formed by a disk drive system, an optical system, and a signal processing system, and is for optically recording/reproducing information to/from an optical disk 1 in which a number of recording layers are layered. In this embodiment, three recording layers L2 to L0 and one guide layer GL are separately formed in the optical disk 1. The recording layers L2, L1, and L0 are positioned in this order from an incidence surface of a laser beam in the optical disk 1 toward a deeper direction therefrom. The guide layer GL is positioned even deeper than the recording layer L0. In the guide layer GL, there are formed guide tracks where disk information is recorded. For example, disk information is formed in advance in an innermost circumferential guide track of the guide layer GL, and is made of specific information of the disk such as recording conditions of the disk, a type of the disk, the number of recording layers, and a distance between the recording layers, and address information (positional information).

Although the disk drive system is not shown in FIG. 1, it includes a clamping mechanism and a disk rotary drive motor, and has a structure such that the optical disk 1 is interposed and held by the clamping mechanism and the optical disk 1 is rotated by the motor.

The optical system is further divided into an optical recording/reproducing system and an optical guide system.

The optical recording/reproducing system includes a light source 11, a collimator lens 12, a beam splitter 13, a spherical aberration correcting element 14, a combining prism 15, an aperture limiting element 16, a quarter wavelength plate 17, an objective lens 18, a multi lens 19, and a photodetector

The light source 11 is a semiconductor laser element which emits a recording/reproducing laser beam (first laser beam) having a wavelength of 405 nm, i.e., recording/reproducing light. A laser beam emitted from the light source 11 is adjusted so as to have p-polarization. The collimator lens 12 converts the laser beam emitted by the light source 11 to parallel light, and supplies the parallel light to the beam splitter 13. The beam splitter 13 is a polarization beam splitter (PBS), and has a separation plane at an angle of 45 degrees with respect to the incidence plane of the laser beam from the collimator lens 12. The beam splitter 13 allows the parallel laser beam with p-polarization supplied from the collimator lens 12 to pass through the separation plane as it is so as to be supplied to the spherical aberration correcting element 14.

The spherical aberration correcting element 14 is formed by a Keplerian expander lens, and includes first and second correcting lenses 14a and 14b. The first correcting lens 14a is driven by an actuator 14c, and provided so as to be movable in an optical axis direction (an arrow A). In the initial state, a distance between the lenses is adjusted so that the incident parallel light is emitted also as parallel light. By moving one lens in the optical axis direction, an emitted beam is changed into diffusion light or convergent light, thereby giving a spherical aberration to the beam condensed by the objective lens 18. That is, by changing the position of the first correcting lens 14a, a distance between the first and second correcting lenses 14a and 14b is changed, thereby enabling the correction of a spherical aberration for each recording layer of the optical disk 1. As an alternative spherical aberration correcting means to the spherical aberration correcting element 14, there is a Galileo type expander lens or a liquid crystal element.

A dichroic prism is used for the combining prism 15. This is an optical element in which reflecting and transmitting characteristics of the combining surface thereof change depending on optical wavelengths. This prism has characteristics such that it reflects a wavelength in the vicinity of 405 nm, which is a wavelength of a recording/reproducing laser beam, and transmits a guide laser beam to be described later (second laser beam), i.e., a wavelength in the vicinity of 660 nm, which is a wavelength of the guide light. With this prism, the recording/reproducing laser beam is reflected to head toward a direction of the optical disk 1.

The aperture limiting element 16 and the quarter wavelength plate 17 are disposed between the combining prism 15 and the objective lens 18.

The aperture limiting element 16 limits an aperture of the guide light, and does not affect the recording/reproducing light at all.

A laser beam passes through the quarter wavelength plate 17 twice, i.e., in an outward path to the optical disk 1 and a return path from the optical disk 1. As a result, the quarter wavelength plate 17 changes the polarization direction of the beam by 90 degrees. This makes the recording/reproducing light returned from the spherical aberration correcting element 14 side to the separation plane of the beam splitter 13 have s-polarization. Thus, the beam splitter 13 performs a reflection action to a beam in the return path. This similarly applies to return guide light in an optical guide system beam splitter 23 to be described later. Moreover, a high-bandwidth quarter wavelength plate is used as the quarter wavelength plate 17, and the quarter wavelength plate 17 functions as a quarter wavelength plate at least for a wavelength of an outgoing beam of the light source 11 and a wavelength of an outgoing beam of a light source 21.

As in an objective lens used for an optical system in the Blu-ray Disk (trademark), the objective lens 18 is optimized for a cover layer of the optical disk 1 with numerical apertures of NA=0.85 and a thickness of 0.1 mm. Where a distance between the first and second correcting lenses 14a and 14b of the spherical aberration correcting element 14 is in the initial state and a distance (working distance) between the objective lens 18 and the surface of the optical disk 1 is set to an optimum value WD0, it is possible to form a most favorable condensed spot on a recording layer positioned 0.1 mm deeper than the surface of the optical disk 1. Moreover, the objective lens 18 includes a focus actuator 18a for moving in an optical axis direction (an arrow B), and a tracking actuator 18b for moving in a direction vertical to the optical axis (an arrow C) so that micromotion in the focus direction and the tracking direction can be electrically controlled.

A recording/reproducing laser beam reflected by any one of the recording layers of the optical disk 1 returns to the beam splitter 13 as a parallel light laser beam via the objective lens 18, the quarter wavelength plate 17, the aperture limiting element 16, the combining prism 15, and the spherical aberration correcting element 14. Since the reflected laser beam has s-polarization, the beam splitter 13 reflects the reflected laser beam with the separation plane at an angle of about 90 degrees with respect to the incidence thereof so as to be supplied to the multi lens 19. The multi lens 19 condenses the reflected laser beam on a light receiving surface of the photodetector 20 to form a spot thereon. Moreover, the multi lens 19 is an optical element in which one surface thereof is formed by a spherical surface, and the other surface thereof is formed by a cylindrical surface, and used for performing focus servo in an astigmatic method. The photodetector 20 includes quartered light receiving surfaces, for example, and generates a voltage signal of a level corresponding to a light receiving intensity for each divided surface.

An output voltage signal of the photodetector 20 is supplied to a reproduction processing circuit not shown in the figure. In the reproduction processing circuit, a reproduction signal of recorded information is generated in accordance with a readout signal (RF signal) obtained from the output voltage signal of the photodetector 20. Moreover, based on an output voltage signal of a photodetector 26, a recording/reproducing focus error signal representing defocus of a condensed spot of recording/reproducing light from a recording layer is obtained at a recording/reproducing focus error signal generating unit 33 to be described later.

The optical guide system shares the combining prism 15, the aperture limiting element 16, the quarter wavelength plate 17, and the objective lens 18 provided in the optical recording/reproducing system, and further includes the light source 21, a collimator lens 22, the beam splitter 23, a magnification conversion element 24, a multi lens 25, and the photodetector 26.

The light source 21 is a semiconductor laser element which emits a guide laser beam with a wavelength of 660 nm. The collimator lens 22 converts the guide laser beam emitted by the light source 21 to parallel light and supplies the parallel light to the beam splitter 23. The beam splitter 23 is a polarization beam splitter (PBS) as with the beam splitter 13, and supplies the parallel laser beam supplied from the collimator lens 22 as it is to the magnification conversion element 24.

The magnification conversion element 24 is provided to move a position of a condensed spot of guide light in the optical axis direction, i.e., a focal point position. This utilizes a property such that a position of a condensed spot generally changes on the optical axis if a diffusion level of a beam incident on a lens is changed (a change in optical magnification). In this embodiment, a Keplerian expander is used as the magnification conversion element. As with the spherical aberration correcting element 14 in the recording/reproducing light, by changing a distance between lenses of the Keplerian expander, a diffusion/convergence level of an outgoing beam is changed. That is, the magnification conversion element 24 includes first and second correcting lenses 24a and 24b. The first correcting lens 24a is driven by an actuator 24c, and provided so as to be movable in an optical axis direction (an arrow D).

The combining prism 15 transmits guide light with a wavelength of 660 nm from the magnification conversion element 24, combines the guide light coaxially with the recording/reproducing light, and supplies the combined light to the aperture limiting element 16.

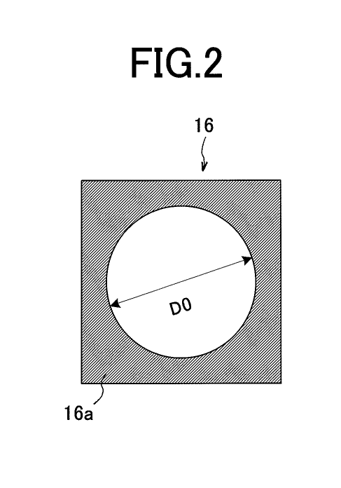

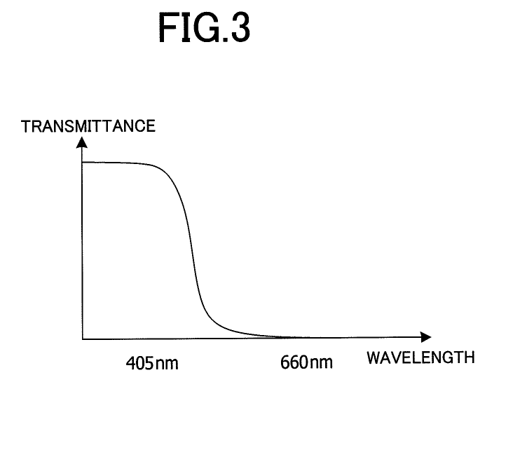

For the guide light with a wavelength of 660 nm, the aperture limiting element 16 limits an aperture diameter to a predetermined size D0 as shown in FIG. 2. Transmittances of the aperture limiting element 16 for wavelengths are as shown in FIG. 3. An element in which a dielectric multilayer film 16a, which transmits recording/reproducing light with a wavelength of 405 nm and reflects guide light with a wavelength of 660 nm, is formed only outside of the aperture diameter D0 can be used. Portions inside and outside the aperture diameter D0 both transmit light with a wavelength of 405 nm.

As described above, the quarter wavelength plate 17 makes the guide light returned from the magnification conversion element 24 side to the separation plane of the beam splitter 23 have s-polarization.

The objective lens 18 forms a condensed spot at a position inside the optical disk 1 for guide light incident from the quarter wavelength plate 17. Since it is possible to adjust the position of this condensed spot in the optical axis direction by the magnification conversion element 24 as described above, a distance between the first and second correcting lenses 24a and 24b is adjusted so that the condensed spot is formed at a depth of the guide layer GL when the working distance is equal to WD0.

For example, the depth of the guide layer GL of the optical disk 1 is set to 0.3 mm, light incident upon the objective lens 18 becomes diffusion light. The objective lens 18 is designed to make light with a wavelength of 405 nm enter as parallel light and to obtain the highest light condensing performance when the cover layer thickness is set to 0.1 mm. Therefore, if it is attempted to make light with a wavelength of 660 nm incident as diffusion light and to form a condensed spot with a distance of a cover layer having a depth of 0.3 mm in the optical disk 1, a great spherical aberration is generated. By limiting the numerical aperture of the guide light to a small value by the aperture limiting element 16, a spherical aberration can be suppressed to be small. For example, although the NA of the recording/reproducing light is set to 0.85 in this embodiment, it is preferred to set the NA of the guide light to about 0.6.

A guide laser beam reflected by the guide layer GL of the optical disk 1 returns to the beam splitter 23 as a parallel light laser beam through the objective lens 18, the quarter wavelength plate 17, the aperture limiting element 16, the combining prism 15, and the magnification conversion element 24. Since the reflected laser beam has s-polarization, the beam splitter 23 reflects the reflected laser beam with the separation plane at an angle of about 90 degrees with respect to the incidence thereof so that the beam is supplied to the multi lens 25. The multi lens 25 condenses the reflected laser beam on the light receiving surface of the photodetector 26 to form a condensed spot thereon.

The photodetector 26 includes quartered light receiving surfaces, for example, and generates a voltage signal of a level corresponding to a light receiving intensity for each divided surface. Based on an output voltage signal of the photodetector 26, there are obtained a guide focus error signal representing defocus of a condensed spot from the guide layer GL, a guide tracking error signal representing defocus from a guide track, and an RF signal, which is a readout signal. The guide focus error signal is obtained at a guide focus error signal generating unit 34 to be described later, and the guide tracking error signal is obtained at a guide tracking error signal generating unit 35 to be described later. Further, the RF signal is obtained at an RF signal generating unit which is not shown in the figure.

Note that the optical system described above is provided so as to be movable in a radial direction of the optical disk 1 by a transfer drive unit which is not shown in the figure.

The signal processing system includes a recording/reproducing light source drive unit 31, a guide light source drive unit 32, the recording/reproducing focus error signal generating unit 33, the guide focus error signal generating unit 34, the guide tracking error generating unit 35, a focus control unit 36, a tracking control unit 37, expander control units 38 and 39, and a main controller 40.

The recording/reproducing light source drive unit 31 performs light emission driving of the light source 11 in accordance with an instruction supplied from the main controller 40. The guide light source drive unit 32 performs light emission driving of the light source 21 in accordance with an instruction supplied from the main controller 40.

The recording/reproducing focus error signal generating unit 33 generates a recording/reproducing focus error signal (first focus error signal) in accordance with an output voltage signal of the photodetector 20. In order to generate the focus error signal, a known signal generating method such as an astigmatic method, for example, may be used. The focus control unit 36 (first focus control means) is connected to the output of the recording/reproducing focus error signal generating unit 33. The focus control unit 36 supplies a focusing drive signal to the focus actuator 18a in accordance with the focus error signal in order to control focusing by the objective lens 18. The focusing drive signal is generated so that the focus error signal is at a zero level.

The guide focus error signal generating unit 34 generates a guide focus error signal (second focus error signal) in accordance with an output voltage signal of the photodetector 26. In order to generate the focus error signal, a known signal generating method such as an astigmatic method, for example, may be used.

The guide tracking error generating unit 35 generates a guide tracking error signal in accordance with an output voltage signal of the photodetector 26. The guide tracking error signal is a signal representing an error in the position of a condensed spot of a guide laser beam to the guide layer GL from the center of the guide track. The tracking control unit 37 is connected to the output of the guide tracking error generating unit 35. The tracking control unit 37 performs tracking servo control, inputs the guide tracking error signal generated by the guide tracking error generating unit 35, and supplies a tracking drive signal to the tracking actuator 18b in order to control a tracking portion by the objective lens 18. The tracking drive signal is generated so that the guide tracking error signal is at a zero level.

The expander control unit 38 drives the actuator 14c of the spherical aberration correcting element 14 in accordance with an instruction supplied from the main controller 40. The main controller 40 supplies, to the expander control unit 38, information to set the correcting lens 14a at an optimum position, i.e., a position to minimize the spherical aberration, for a recording layer to be subjected to recording/reproduction. For example, in the main controller 40, respective optimum positions of the correcting lens 14a corresponding to the recording layers are stored in advance in a memory (not shown in the figure). When a target recording layer for recording/reproduction is determined, information about the position of the correcting lens 14a corresponding to that recording layer is read out from the memory, and the expander control unit 38 is instructed to move the correcting lens 14a to that position.

The expander control unit 39 is connected to the output of the guide focus error signal generating unit 34, and is a second focus control means for driving the actuator 24c of the magnification conversion element 24 in accordance with an instruction supplied from the main controller 40. The expander control unit 39 drives the actuator 24c so that the guide focus error signal is at a zero level, thereby adjusting the position of the correcting lens 24a at an optimum position.

Along with the control of the expander control units 38 and 39, the main controller 40 controls ON and OFF of focus servo control by the above-described focus control unit 36 and ON and OFF of tracking servo control by the tracking control unit 37.

Moreover, the main controller 40 controls a drive power of the recording/reproducing light source drive unit 31. An operating mode includes a recording mode during which information is recorded on the optical disk 1, and a reproduction mode during which information recorded on the optical disk 1 is reproduced. The drive power during the recording mode (recording power) is set to be greater than the reproduction power during the reproduction mode.

In the optical disk drive device with such a configuration, in a case where information is recorded on the optical disk 1, a recording instruction from an operating unit, which is not shown in the figure, is supplied to the main controller 40.

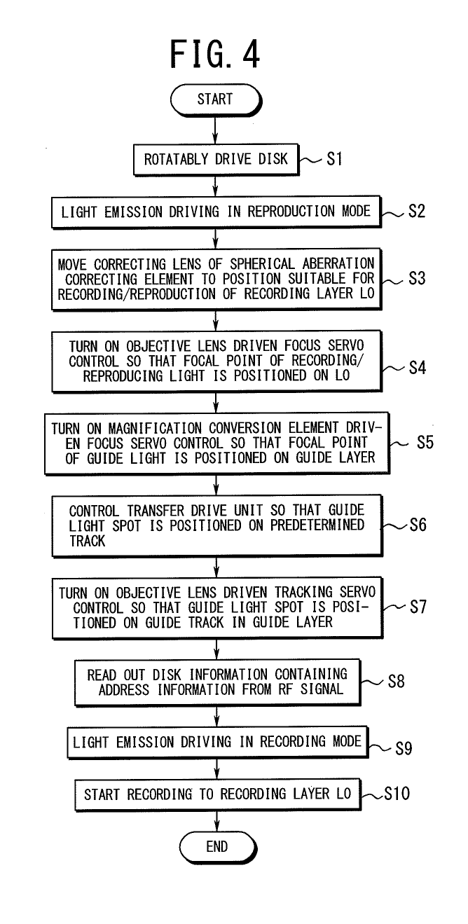

The main controller 40 starts a recording operation in accordance with the recording instruction. As shown in FIG. 4, first, the main controller 40 rotatably drives the optical disk 1 by the above-described disk drive unit (step S1), and generates a light emission driving instruction in the reproduction mode with respect to the recording/reproducing light source drive unit 31 and the guide light source drive unit 32 (step S2). The recording/reproducing light source drive unit 31 drives the light source 11 with a reproduction power so as to emit a reproducing laser beam, and the guide light source drive unit 32 drives the light source 21 so as to emit a guide laser beam. Note that steps S1 and S2 are omitted in a case where the optical disk 1 has already been rotatably driven and light emission driving of the light sources 11 and 21 has been performed.

The main controller 40 instructs the expander control unit 38 to set the position of the correcting lens 14a of the spherical aberration correcting element 14 to a position suitable for recording/reproduction of the deepest recording layer L0 of the optical disk 1 (step S3), and instructs the focus control unit 36 to turn ON the focus servo control of the recording/reproducing light (step S4). By turning ON the focus servo control, there is formed a focus servo loop configured by the optical recording/reproducing system, the focus error generating unit 33, the focus control unit 36, and the focus actuator 18a. Therefore, the focus control unit 36 generates a focusing drive signal so that the focus error signal generated by the recording/reproducing focus error signal generating unit 33 is at a zero level, and the position of the objective lens 18 in the optical axis direction is thereby controlled. As a result, the condensed spot of the recording/reproducing laser beam, i.e., the focal point of the recording/reproducing light, is made to position on the deepest recording layer L0 of the optical disk 1.

Next, the main controller 40 instructs the expander control unit 39 to make the focal point of the guide light positioned on the guide layer GL (step S5). In step S5, the expander control unit 39 first drives the actuator 24c to move the position of the correcting lens 24a. By moving the correcting lens 24a, the focal point of the guide light is scanned. The guide focus error signal generated by the guide focus error signal generating unit 34 changes as shown in FIG. 13 depending on a position of the correcting lens 24a when the focal point of the guide light passes across the guide layer. If the guide focus error signal is within the capture range, it can be specified that the focal point of the guide light is positioned in the vicinity of the guide layer.

Here, the focus servo of the guide light is turned ON, and the actuator 24c is driven so that the guide focus error signal is at a zero level. As a result, the position of the correcting lens 24a is adjusted to an optimum position, and the condensed spot of the guide laser beam, i.e., the focal point of the guide light, is therefore made to position on the guide layer GL of the optical disk 1.

The main controller 40 controls the above-described transfer drive unit so that the condensed spot of the guide laser beam is positioned on a predetermined track (for example, the innermost circumferential track) of the guide layer GL (step S6). Then, the main controller 40 instructs the tracking control unit 37 to turn ON the tracking servo control (step S7). By turning ON the tracking servo control, there is formed a tracking servo loop configured by the optical guide system, the guide tracking error generating unit 35, the tracking control unit 37, and the tracking actuator 18b. Therefore, the tracking control unit 37 generates a tracking drive signal so that the guide tracking error signal is at a zero level, and the position of the objective lens 18 in the radial direction is thereby controlled. The condensed spot of the guide laser beam is positioned on the guide track of the guide layer GL in the optical disk 1. When the position of the condensed spot of the guide laser beam is determined, the above-described disk information such as address information and the number of recording layers recorded on the guide layer GL is read out from the RF signal, which is a readout signal by the guide light (step S8).

Thereafter, the main controller 40 instructs the recording/reproducing light source drive unit 32 to switch to the recording mode (step S9), and recording to the recording layer L0 is started based on the disk information obtained in step S8 (step S10). In the recording mode, a drive power for the light source 11 of the recording/reproducing light source drive unit 31 is set to a recording power greater than the reproduction power, and the light source 11 is driven in accordance with information to be recorded, thereby disposing the condensed spot of a modulated recording laser beam on the recording layer L0. The condensed spot of the recording laser beam moves on the recording layer L0 while tracking the guide track of the guide layer GL. As a result, a recording track is formed.

As described above, when the condensed spot of the recording/reproducing light is on the target recording layer L0 and after the condensed spot of the guide light becomes ready to track the guide track of the guide layer GL, recording to the recording layer L0 is performed. Since a condensed spot of the guide light and a condensed spot of the recording/reproducing light are always on the same axis, by performing modulation in accordance with a recording signal of the light source 11 in such a state, it becomes possible to form a recording track made of information pit strings along the guide track on the recording layer L0.

Also in a case where recording is directly started using the recording layer L1 or L2 other than the recording layer L0 as a target recording layer, recording can be performed in a similar manner to the operation described above.

Thus, in a recording operation to any one of the recording layers in the optical disk 1, focusing on one recording layer by the recording/reproducing light is performed by the control of the objective lens 18 and focusing on the guide layer GL by the guide light is further performed by the control of the magnification conversion element 24. As a result, focusing on that recording layer can be performed accurately and stably. That is, since the condensed spot by the recording/reproducing light, which is minuter than that by the guide light, is used, there is an advantage that the highly-accurate and stable control of the objective lens 18 can be used in the focus tracking operation to the recording layer, which requires an accuracy and a stability during recording.

If recording to one recording layer is completed, recording is performed after moving to another recording layer. In a similar manner to a typical focus jump procedure in a two-layer optical disk, a procedure to move from a recording layer to an adjacent recording layer may be performed in such a way that (1) focus servo control is turned OFF, (2) the focus actuator 18a of the objective lens 18 is driven to move the objective lens 18 in a jump direction, and (3) a focus error signal is monitored, and when it comes close to the next zero cross point, focus servo control is turned ON.

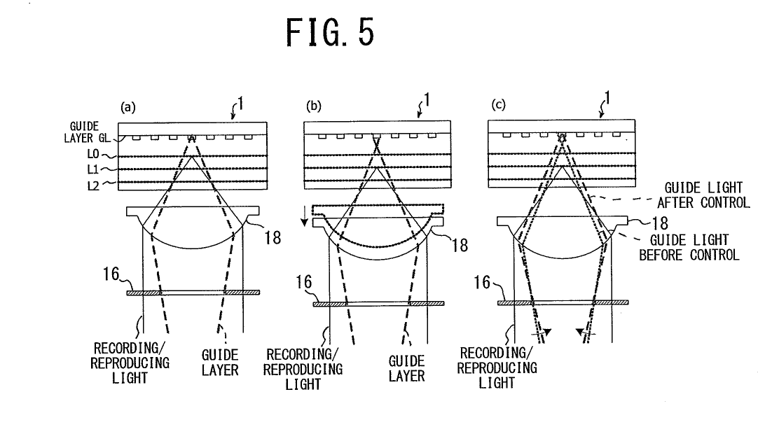

As shown in FIG. 5(a), in order to move from the recording layer L0 to the adjacent recording layer L1, in a state where the recording/reproducing light is tracking the recording layer L0, the turn-off of the focus servo control in (1) described above is first performed. Next, as shown in FIG. 5(b), the movement of the objective lens 18 in the jump direction in (2) described above is performed. As a result, the condensed spot of the recording/reproducing light is positioned in the vicinity of the recording layer L1. Then, the turn-on of the focus servo control in (3) described above is performed. While the guide light is focused short of the guide layer GL, if the focus servo of the guide light is in operation, a diffusion level of the guide light is controlled so that the condensed spot of the guide light tracks the guide layer GL. Therefore, the position of the correcting lens 24a of the magnification conversion element 24 is controlled so that the condensed spot is positioned on the guide layer GL as shown in FIG. 5(c). Then, the position of the correcting lens 24a is controlled in a direction closer to the correcting lens 24b.

In order to reproduce information recorded on the optical disk 1, there are two methods as tracking servo control methods. One is a method for tracking a track of the guide layer GL with the guide light in a similar manner to recording. The other is a method for making the recording/reproducing light track a mark string (pit string) of a recording layer which has been recorded. Taking into consideration a possibility of a misalignment between the guide track and the recorded mark string due to a tilt of the optical disk 1, it is preferable to use a method directly tracking the recorded mark string.

Here, there is no need to use the guide light and the optical guide system, and only the optical recording/reproducing system is used. In a similar manner to the time of recording, reflected light from the recording layer is received by the photodetector 20, and a reproduction signal, a focus error signal, and a tracking error signal are obtained therefrom. Based on the focus error signal, the position of the objective lens 18 in the optical axis direction is controlled so that the condensed spot of the recording/reproducing light tracks on the recording layer, and based on the tracking error signal, the position of the objective lens 18 in the tracking direction is controlled so that the condensed spot tracks the recorded mark string. Then, the spherical aberration correcting element 14 is controlled so that the amplitude of the reproduction signal reaches its maximum.

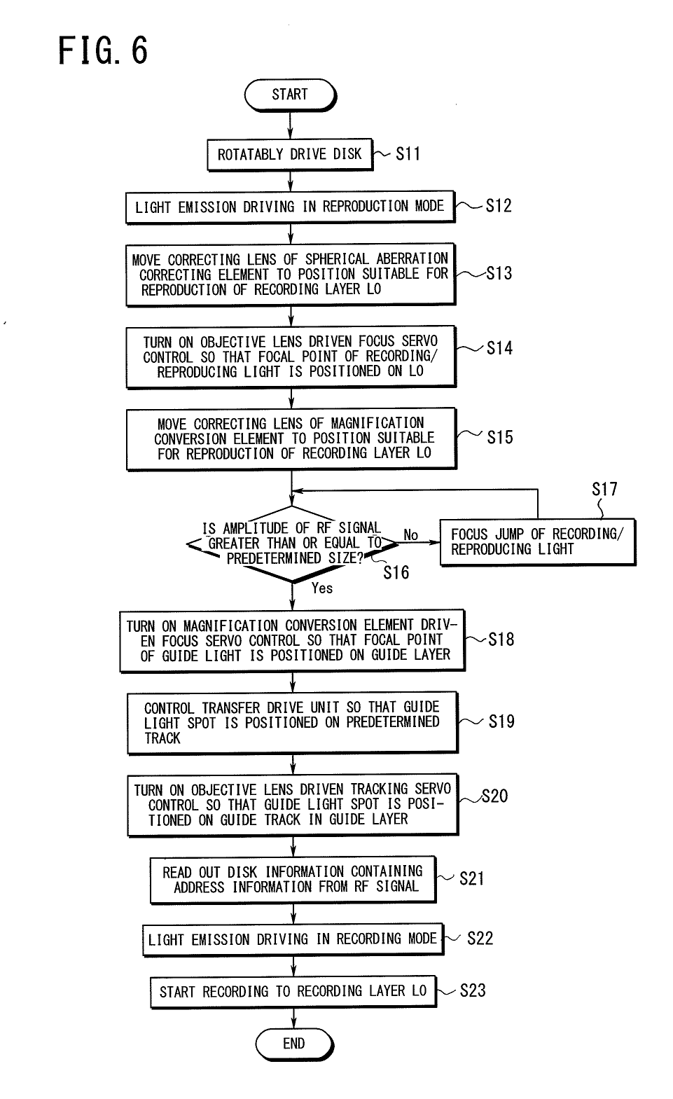

FIG. 6 shows a modification of the recording operation. In the recording operation of FIG. 6, the main controller 40 rotatably drives the optical disk 1 by the above-described disk drive unit (step S11), and generates a light emission driving instruction in the reproduction mode with respect to the recording/reproducing light source drive unit 31 and the guide light source drive unit 32 (step S12). The main controller 40 instructs the expander control unit 38 to set the position of the correcting lens 14a of the spherical aberration correcting element 14 to a position suitable for recording/reproduction of the deepest recording layer L0 of the optical disk 1 (step S13), and instructs the focus control unit 36 to turn ON the focus servo control of the recording/reproducing light (step S14). These steps S11 to S14 are the same as steps S1 to S4 in the recording operation of FIG. 4.

Next, the main controller 40 instructs the expander control unit 39 to set the position of the correcting lens 24a of the magnification conversion element 24 to a position suitable for recording/reproduction of the deepest recording layer L0 of the optical disk 1 (step S15), and determines whether or not the amplitude of the RF signal obtained based on the output signal of the photodetector 26 is greater than or equal to a predetermined size (step S16). If the amplitude of the RF signal is smaller than the predetermined size, the main controller 40 instructs the focus control unit 36 to perform a focus jump of the recording/reproducing light (step S17). If the amplitude of the RF signal in step S16 is less than the predetermined size, the focus control unit 36 moves the objective lens 18 in the optical axis direction by a predetermined amount in response to the instruction of step S17 so as to perform a focus jump of the recording/reproducing light. The focus jump of the recording/reproducing light is repeated until the amplitude of the RF signal reaches the predetermined size or greater.

If the amplitude of the RF signal in step S16 reaches the predetermined size or greater, steps S18 to S23 are performed. Steps S18 to S23 are the same as steps S5 to S10 in the recording operation of FIG. 4.

By moving the correcting lens 24a on the guide light side, the position of the condensed spot of the guide light can be moved in the optical axis direction. Therefore, even if the working distance WD between the objective lens 18 and the optical disk 1 is changed, the condensed spot of the guide light can be disposed on the guide layer GL of the optical disk 1 by the movement of the correcting lens 24a. Conversely, when the working distance WD is set to a predetermined fixed value, the correcting lens 24a is always in place. When the correcting lens 14a in the optical recording/reproducing system is at a predetermined position and the focal point of the recording/reproducing light is positioned on the recording layer L0, the working distance WD is equal to the predetermined value WD0 and the position of the correcting lens 24a for placing the condensed spot of the guide light on the guide layer GL in such a state is also at the predetermined position. The position of the correcting lens 24a at this point is the above-described position of the correcting lens 24a which is optimum for recording/reproduction of the recording layer L0. In step S15, the position of the correcting lens 24a is set to such a predetermined position.

Therefore, if the focal point of the recording/reproducing light is positioned on the recording layer L0 in step S14, the condensed spot of the guide light is also positioned on the guide layer GL. Therefore, the amplitude of the RF signal read out by the guide light becomes a sufficiently large value. However, in a state where the focal point of the recording/reproducing light is positioned on another recording layer other than the recording layer L0, the value of the working distance WD is not equal to the predetermined value WD0. Therefore, the position of the condensed spot of the guide light is defocused from the guide layer GL, thereby resulting in a small amplitude of the RF signal reproduced by the guide light. That is, the state in which the amplitude of the RF signal read out by the guide light is greater than or equal to the predetermined size corresponds to the state in which the focal point of the recording/reproducing light is positioned on the recording layer L0. By repeating the focus jump of the recording/reproducing light to the recording layer L0 side by step S17 and by searching the position of the guide light at which the amplitude of the RF signal coincides with this state in step S16, it is possible to reliably set the focal point position of the recording/reproducing light on the recording layer L0.

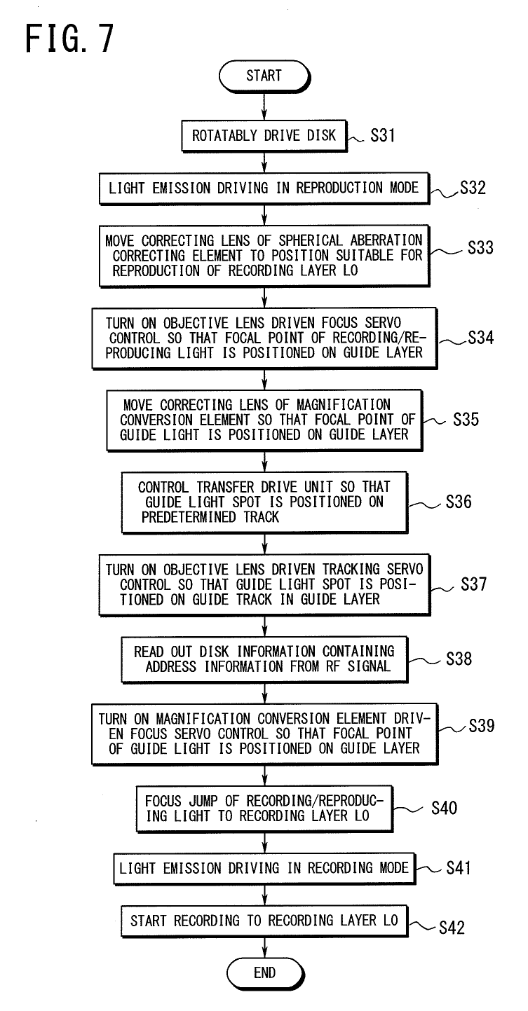

FIG. 7 shows a further modification of the recording operation. In the recording operation of FIG. 7, the main controller 40 rotatably drives the optical disk 1 by the above-described disk drive unit (step S31), and generates a light emission driving instruction in the reproduction mode with respect to the recording/reproducing light source drive unit 31 and the guide light source drive unit 32 (step S32). The main controller 40 instructs the expander control unit 38 to set the position of the correcting lens 14a of the spherical aberration correcting element 14 to a position suitable for reproduction of the guide layer GL of the optical disk 1 (step S33), and instructs the focus control unit 36 to turn ON the focus servo control of the recording/reproducing light (step S34). Steps S31 and S32 are the same as steps S1 and S2 in the recording operation of FIG. 4. By performing steps S33 and S34, the focal point of the recording/reproducing light is positioned on the guide layer GL.

Next, the main controller 40 instructs the expander control unit 39 to place the focal point of the guide light on the guide layer GL (step S35). In step S35, the expander control unit 39 drives the actuator 24c to move the position of the correcting lens 24a. Then, there is obtained a guide focus error signal as shown in FIG. 13 depending on a position of the correcting lens 24a. By controlling the position of the correcting lens 24a so that the guide focus error signal is in the vicinity of the zero cross point within the capture range, the position of the condensed spot of the guide laser beam is positioned near the guide layer. Then, the main controller 40 controls the above-described transfer drive unit so that the condensed spot of the guide laser beam is positioned on a predetermined track (for example, the innermost circumferential track) of the guide layer GL (step S36). Although the focus servo control by the guide light is off at this point, since the objective lens and the guide layer are being controlled to have a constant distance by the focus control of the recording/reproducing light, the condensed spot of the guide light also performs tracking on the guide layer GL in such a state. Thereafter, the main controller 40 instructs the tracking control unit 37 to turn ON the tracking servo control (step S37). When the position of the condensed spot of the guide laser beam is determined, disk information such as address information and the number of recording layers recorded on the guide layer GL is read out from the RF signal, which is a readout signal by the guide light (step S38).

The main controller 40 instructs the expander control unit 39 to turn ON the guide focus servo control (step S39). The expander control unit 39 drives the actuator 24c so that the guide focus error signal is at a zero level in step S39, thereby adjusting the position of the correcting lens 24a so that the guide light tracks the guide layer GL even only with the optical guide system. As a result, even if the focal point position of the recording/reproducing light moves from the guide layer GL to a recording layer, the focal point of the guide light can remain on the guide layer GL. Thus, the main controller 40 next instructs the focus control unit 36 to perform a focus jump of the recording/reproducing light to the recording layer L0 (step S40). Then, the main controller 40 instructs the recording/reproducing light source drive unit 31 to switch to the recording mode (step S41), and the recording/reproducing light is modulated based on the disk information read out in step S38 to perform recording to the recording layer L0 (step S42).

As described above, according to the recording operation of FIG. 7, the focal point of the recording/reproducing light is once positioned on the guide layer GL of the optical disk 1. This is because there is a case in which focusing the recording/reproducing light on the guide layer is more reliable than focusing the recording/reproducing light on a particular recording layer in a case where the guide layer is positioned at an edge of a recording layer or in a case where a distance between the guide layer and a recording layer is set to be larger than the distance between recording layers. Furthermore, since the recording layer L0 is positioned next to the guide layer GL, the movement of the focal point of the recording/reproducing light from the guide layer GL to the recording layer L0 can be reliably performed.

Note that the focus servo of the guide light in step S39 may be performed at a stage prior to the reading out of the disk information from the guide layer GL in step S38.

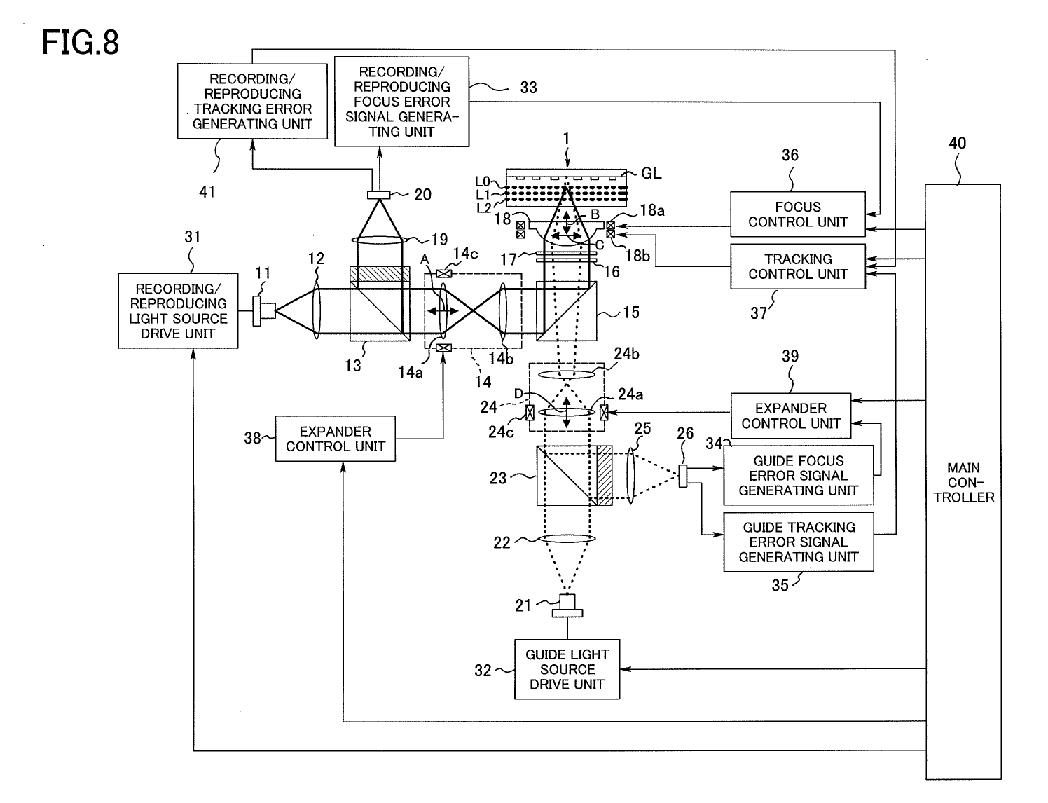

FIG. 8 shows another configuration of a multilayer optical disk recording/reproducing device to which the present invention is applied. In this multilayer optical disk recording/reproducing device, the recording/reproducing focus error signal generating unit 33 and a recording/reproducing tracking error signal generating unit 41 are connected to the photodetector 20. The recording/reproducing tracking error signal generating unit 41 generates a recording/reproducing tracking error signal in accordance with an output voltage signal of the photodetector 20. The recording/reproducing tracking error signal is a signal representing an error of the condensed spot position of the recording/reproducing laser beam to the guide layer GL or a recording layer from the center of the guide track. Moreover, the recording/reproducing tracking error signal is supplied to the tracking control unit 37. During the tracking servo control, the tracking control unit 37 selectively uses either one of the guide tracking error signal from the guide tracking error signal generating unit 35 and the recording/reproducing tracking error signal from the recording/reproducing tracking error signal generating unit 41 in accordance with the instruction of the main controller 40. The other configurations are the same as those of the multilayer optical disk recording/reproducing device in FIG. 1.

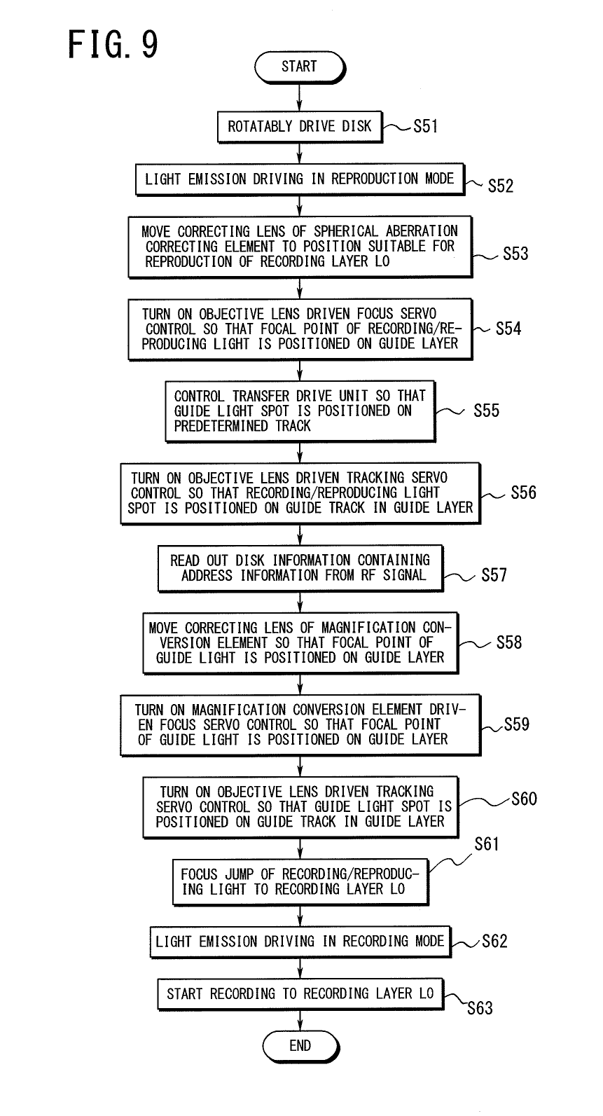

In the recording operation of the multilayer optical disk recording/reproducing device in FIG. 8, as shown in FIG. 9, the main controller 40 rotatably drives the optical disk 1 by the above-described disk drive unit (step S51), and generates a light emission driving instruction in the reproduction mode with respect to the recording/reproducing light source drive unit 31 and the guide light source drive unit 32 (step S52). The main controller 40 instructs the expander control unit 38 to set the position of the correcting lens 14a of the spherical aberration correcting element 14 to a position suitable for reproduction of the guide layer GL of the optical disk 1 (step S53), and instructs the focus control unit 36 to turn ON the focus servo control of the recording/reproducing light (step S54). Steps S51 to S54 are the same as steps S31 to S34 in the recording operation of FIG. 7. By performing steps S53 and S54, the focal point of the recording/reproducing light is positioned on the guide layer GL.

Next, the main controller 40 controls the above-described transfer drive unit so that the condensed spot of the recording/reproducing laser beam is positioned on a predetermined track (for example, the innermost circumferential track) of the guide layer GL (step S55). Then, the main controller 40 instructs the tracking control unit 37 to turn ON the recording/reproducing tracking servo control (step S56). By turning ON the recording/reproducing tracking servo control, there is formed a tracking servo loop configured by the optical recording/reproducing system, the recording/reproducing tracking error generating unit 41, the tracking control unit 37, and the tracking actuator 18b. Therefore, the tracking control unit 37 generates a tracking drive signal so that the recording/reproducing tracking error signal is at a zero level, and the position of the objective lens 18 in the radial direction is thereby controlled. As a result of this control, the condensed spot of the recording/reproducing laser beam is positioned on the guide track of the guide layer GL in the optical disk 1. When the position of the condensed spot of the recording/reproducing laser beam is determined, the above-described disk information such as address information and the number of recording layers recorded on the guide layer GL is read out from the RF signal, which is a readout signal by the recording/reproducing light (step S57).

After performing step S57, the main controller 40 instructs the expander control unit 39 to place the focal point of the guide light on the guide layer GL (step S58). In step S58, the expander control unit 39 drives the actuator 24c to move the position of the correcting lens 24a. Then, the main controller 40 instructs the expander control unit 39 to turn ON the guide focus servo control (step S59). In step S59, since the expander control unit 39 drives the actuator 24c so that the guide focus error signal is at a zero level, the position of the correcting lens 24a is adjusted, and the focal point of the guide light thereby tracks the guide layer GL even only with the optical guide system.

After performing step S59, the main controller 40 instructs the tracking control unit 37 to turn ON the guide tracking servo control (step S60). By turning ON the guide tracking servo control, the recording/reproducing tracking servo control is turned OFF, and there is formed a tracking servo loop configured by the optical guide system, the guide tracking error generating unit 35, the tracking control unit 37, and the tracking actuator 18b. Therefore, the tracking control unit 37 generates a tracking drive signal so that the guide tracking error signal is at a zero level, and the position of the objective lens 18 in the radial direction is thereby controlled. As a result of this control, the condensed spot of the guide laser beam is positioned on a guide track of the guide layer GL in the optical disk 1.

Next, the main controller 40 instructs the focus control unit 36 to perform a focus jump of the recording/reproducing light to the recording layer L0 (step S61). Then, the main controller 40 instructs the recording/reproducing light source drive unit 31 to switch to the recording mode (step S62), and the recording/reproducing light is modulated based on the disk information read out in step S57 to perform recording to the recording layer L0 (step S63).

According to the recording operation of FIG. 9 as described above, first, the focal point of the recording/reproducing light is once positioned on the guide layer GL of the optical disk 1, and the objective lens driven tracking servo control to the guide layer by the recording/reproducing light is further performed. Therefore, the disk information recorded on the guide layer can be read out by the recording/reproducing light at an early stage. After reading out the disk information, it is switched to an objective lens driven tracking servo control of the guide light to the guide layer. Therefore, based on the disk information, it is also possible to reliably perform a focus jump movement of the focal point of the recording/reproducing light from the guide layer to the recording layer L0.

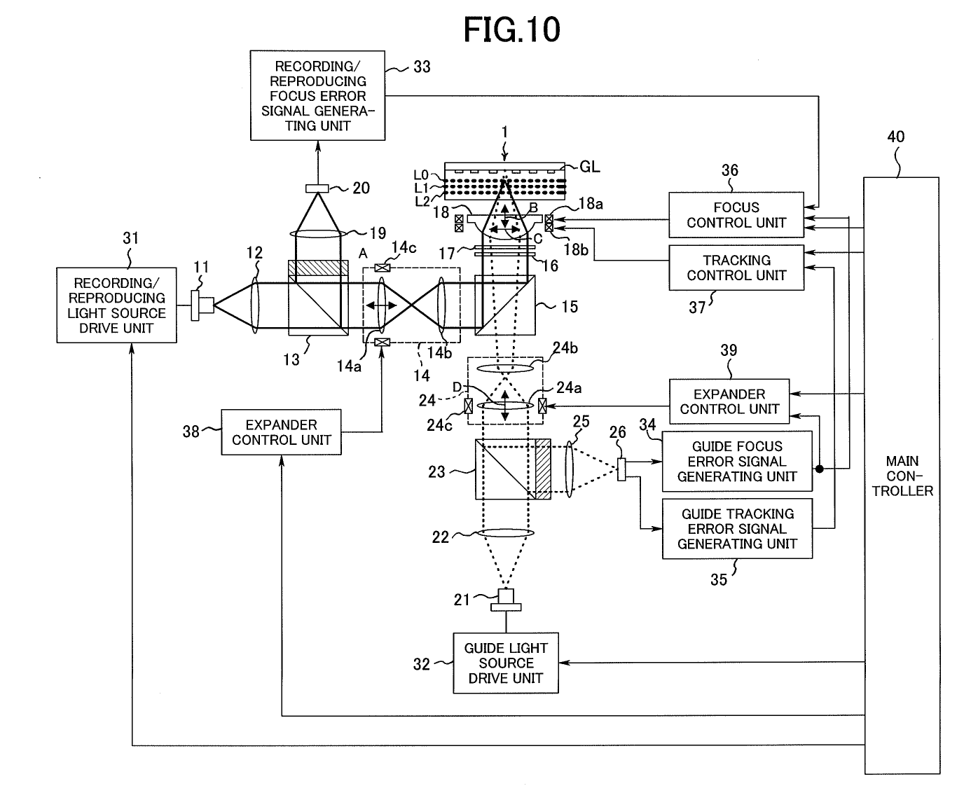

FIG. 10 shows yet another configuration of a multilayer optical disk recording/reproducing device to which the present invention is applied. In this multilayer optical disk recording/reproducing device, an output signal of the guide focus error signal generating unit 34 is supplied to the expander control unit 39 and the focus control unit 36. During the focus servo control, the focus control unit 36 selectively uses either one of the guide focus error signal from the guide focus error signal generating unit 34 and the recording/reproducing focus error signal from the recording/reproducing focus error signal generating unit 33 in accordance with the instruction of the main controller 40. As focus servo control by a guide focus error signal, an astigmatic method, for example, may be used. The other configurations are the same as those of the multilayer optical disk recording/reproducing device in FIG. 1.

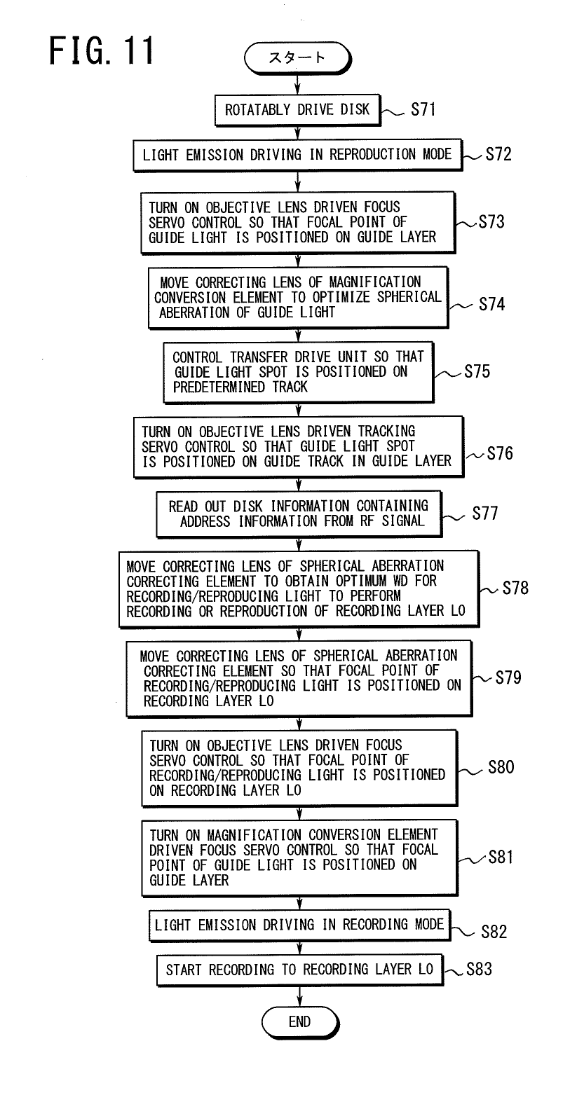

In the recording operation of the multilayer optical disk recording/reproducing device in FIG. 10, as shown in FIG. 11, the main controller 40 rotatably drives the optical disk 1 by the above-described disk drive unit (step S71), generates a light emission driving instruction in the reproduction mode with respect to the recording/reproducing light source drive unit 31 and the guide light source drive unit 32 (step S72), and instructs the focus control unit 36 to turn ON the focus servo control of the guide light (step S73). By turning ON the focus servo control by the guide light, there is formed a focus servo loop configured by the optical guide system, the focus error generating unit 34, the focus control unit 36, and the focus actuator 18a. Therefore, the focus control unit 36 generates a focusing drive signal so that the focus error signal generated by the guide focus error signal generating unit 34 is at a zero level, and the position of the objective lens 18 in the optical axis direction is thereby controlled. As a result, the focal point of the guide light is made to position on the guide layer GL of the optical disk 1.

During the execution of the focus servo control of the guide light, the main controller 40 instructs the expander control unit 39 to move the position of the correcting lens 24a of the magnification conversion element 24 so as to optimize the spherical aberration of the guide light (step S74). In response to the instruction of step S74, the magnification conversion element 24 is used as a spherical aberration correcting element, and the position of the correcting lens 24a is moved to a position at which the amplitude of the guide focus error signal reaches its maximum. Furthermore, the main controller 40 controls the above-described transfer drive unit so that the condensed spot of the guide laser beam is positioned on a predetermined track (for example, the innermost circumferential track) of the guide layer GL (step S75). Then, the main controller 40 instructs the tracking control unit 37 to turn ON the tracking servo control (step S76). By turning ON the tracking servo control, there is formed a tracking servo loop configured by the optical guide system, the guide tracking error generating unit 35, the tracking control unit 37, and the tracking actuator 18b. Therefore, the tracking control unit 37 generates a tracking drive signal so that the guide tracking error signal is at a zero level, and the position of the objective lens 18 in the radial direction is thereby controlled. The condensed spot of the guide laser beam is positioned on a guide track of the guide layer GL in the optical disk 1. When the position of the condensed spot of the guide laser beam is determined, the above-described disk information such as address information and the number of recording layers recorded on the guide layer GL is read out from the RF signal, which is a readout signal by the guide light (step S77).

Next, the main controller 40 instructs the expander control unit 39 to move the position of the correcting lens 24a of the magnification conversion element 24 (step S78). In step S78, the position of the correcting lens 24a is determined so that the working distance WD is equal to an optimum value to focus the recording/reproducing light on the recording layer L0. Since the working distance WD has been set to the optimum value to focus the guide light on the guide layer GL by the execution of step S74, step S78 performs a change to the optimum value to focus the recording/reproducing light on the recording layer L0. That is, even if a diffusion state of the guide light incident upon the objective lens 18 is changed by the movement in the position of the correcting lens 24a, the focus servo control of the guide light changes the position of the objective lens 18 in the optical axis direction in order to maintain a focused state of the guide light to the guide layer GL. Therefore, the working distance WD is set to an appropriate value for focusing the recording/reproducing light on the recording layer L0.

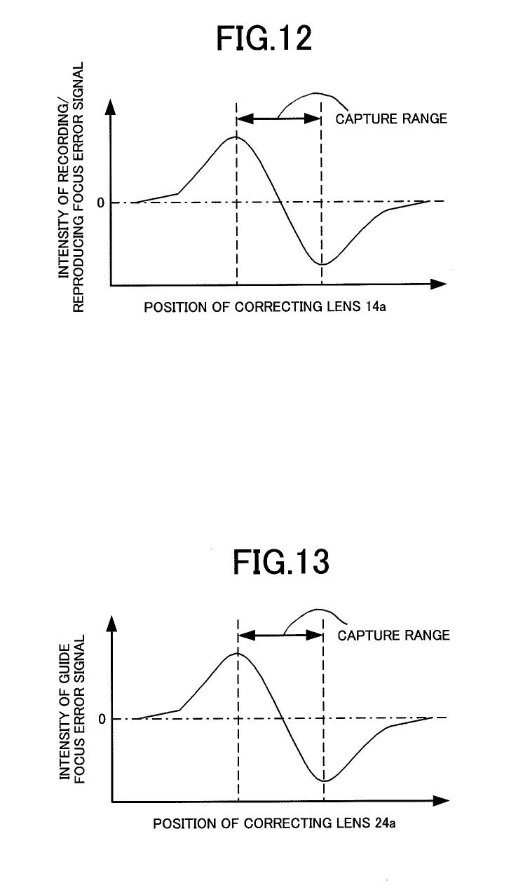

After the execution of step S78, the main controller 40 instructs the expander control unit 38 to move the correcting lens 14a of the spherical aberration correcting element 14 so that the focal point of the recording/reproducing light is positioned in the vicinity of the recording layer L0 (step S79). By the execution of step S79, the expander control unit 38 first moves the correcting lens 14a so that the focal point of the recording/reproducing light is positioned between the guide layer GL and the recording layer L0 closest to the guide layer GL. By moving the correcting lens 14a, the focal point of the recording/reproducing light is scanned. Then, the recording/reproducing focus error signal changes as shown in FIG. 12 depending on a position of the correcting lens 14a when the focal point of the recording/reproducing light passes across the recording layer. If the recording/reproducing focus error signal is within the capture range, it can be specified that the focal point of the recording/reproducing light is positioned in the vicinity of the recording layer L0. Moreover, it can be also specified that it is positioned in the vicinity of another recording layer other than the recording layer L0 by counting zero crossing of the recording/reproducing focus error signal. At a zero cross point within the capture range in the recording/reproducing focus error signal corresponding to the recording layer L0, the main controller 40 instructs the focus control unit 36 to turn ON the focus servo control of the recording/reproducing light (step S80). By turning ON the focus servo control of the recording/reproducing light, the focus servo control of the guide light is turned OFF, and there is formed a focus servo loop configured by the optical recording/reproducing system, the focus error generating unit 33, the focus control unit 36, and the focus actuator 18a. Therefore, the focus control unit 36 generates a focusing drive signal so that the focus error signal generated by the recording/reproducing focus error signal generating unit 33 is at a zero level, and the position of the objective lens 18 in the optical axis direction is thereby controlled. As a result, the focal point of the recording/reproducing light is made to position on the recording layer L0 of the optical disk 1.

Furthermore, the main controller 40 instructs the expander control unit 39 to turn ON the guide focus servo control (step S81). Since the expander control unit 39 drives the actuator 24c in step S81 so that the guide focus error signal is at a zero level, the position of the correcting lens 24a is adjusted and the focal point of the guide light thus tracks the guide layer GL. Then, the main controller 40 instructs the recording/reproducing light source drive unit 31 to switch to the recording mode (step S82), and the recording/reproducing light is modulated based on the disk information read out in step S77 to perform recording to the recording layer L0 (step S83).

As described above, according to the recording operation in FIG. 11, since the objective lens driven focus servo control and tracking servo control to the guide layer by the guide light are first performed, focus locking can be stably performed and the disk information recorded on the guide layer by the guide light can be read out at an early stage. Furthermore, while being focus-controlled to the guide layer, a distance between the optical disk 1 and the objective lens 18 is kept constant. Therefore, it becomes easier to specify a recording layer to be focus-controlled by the recording/reproducing light.

Thus, by accurately counting the number of recording layers through which the focal point of the recording/reproducing light is passed using the focus error signal obtained by moving the correcting lens 14a of the spherical aberration correcting element 14 in the optical axis direction and scanning the focal point of the recording/reproducing light in the thickness direction of the disk, it is possible to easily specify the target recording layer such as the recording layer L0.

Note that while the optical disk includes a plurality of recording layers along with a single guide layer in the respective embodiments described above, it is only necessary that the optical disk includes at least one recording layer and a guide layer provided spaced apart from each other in a layered form. The optical disk may include a plurality of guide layers. Moreover, as an optical recording medium, it may be an optical memory in which a plurality of recording layers are layered instead of a disk whose shape is discoidal as in the embodiments.

Furthermore, the order of the recording operation steps shown in FIGS. 4, 6, 7, 9, and 11 in the respective embodiments described above is not particularly limited, and can be changed appropriately.

The present invention can be applied not only to an optical disk drive device but also to other devices such as a hard disk recording/reproducing device including an optical disk drive device.

### REFERENCE SIGNS LIST

1 Optical disk
11, 21 Light source
14 Spherical aberration correcting element
18 Objective lens
20, 26 Photodetector
24 Magnification conversion element
40 Main controller

1-11. (canceled)

12. An optical recording medium drive device for optically recording information in accordance with a guide track to a recording layer of a separated guide layer type optical recording medium in which a guide layer having the guide track formed thereon and the recording layer are layered so as to be spaced apart from each other, comprising:
a first light source which generates a first laser beam for recording;
a second light source which generates a second laser beam for guiding;
a combining prism which combines the first laser beam with the second laser beam so as to coaxially guide the combined beams;
an objective lens which condenses the respective first and second laser beams from the combining prism toward the optical recording medium;
a first photodetecting unit which detects reflected light of the first laser beam from the recording layer;
a second photodetecting unit which detects reflected light of the second laser beam from the guide layer;
a magnification conversion element disposed on an optical path of the second laser beam between the second light source and the combining prism, which diffuses or converging the second laser beam incident upon the objective lens;
a first focus error generating unit which generates a first focus error signal indicating an error between a condensed spot position of the first laser beam and the recording layer based on an output signal of the first photodetecting unit;
a second focus error generating unit which generates a second focus error signal indicating an error between a condensed spot position of the second laser beam and the guide layer based on an output signal of the second photodetecting unit;
a first focus controller which controls the objective lens in an optical axis direction thereof in accordance with the first focus error signal;
a second focus controller which controls a magnitude of the diffusion or convergence of the second laser beam by the magnification conversion element in accordance with the second focus error signal;
a first tracking error generating unit which generates a first tracking error signal indicating an error between the condensed spot position of the first laser beam and the guide track of the guide layer based on the output signal of the first photodetecting unit;
a second tracking error generating unit which generates a second tracking error signal indicating an error between the condensed spot position of the second laser beam and the guide track of the guide layer based on the output signal of the second photodetecting unit;
a tracking controller which drives and controls the objective lens in a direction vertical to the optical axis direction thereof in accordance with the tracking error signal;
a spherical aberration correcting element disposed on an optical path of the first laser beam between the first light source and the combining prism;
a spherical aberration controller which controls a correction state of a spherical aberration by the spherical aberration correcting element; and
a main controller,
wherein the main controller reads out recording medium information based on the output signal of the first photodetecting unit, when the spherical aberration controller controls the spherical aberration correcting element so as to be in a correction state optimum for reproduction of the guide layer, a focal point of the first laser beam is positioned on the guide layer by the control of the objective lens by the first focus controllers in accordance with the first focus error signal, and the tracking controller controls the objective lens in accordance with the first tracking error signal so that the condensed spot position of the first laser beam is positioned on the guide track of the guide layer, and
modulates the first laser beam to start recording to the recording layer based on the recording medium information, when the second focus controller controls the magnification conversion element so that a focal point of the second laser beam is positioned on the guide layer, the second focus controller controls the magnification conversion element in accordance with the second focus error signal so that the focal point of the second laser beam is positioned on the guide layer, the tracking controller controls the objective lens in accordance with the tracking error signal so that the condensed spot position of the second laser beam is positioned on the guide track of the guide layer, and the focal point of the first laser beam has performed a focus jump to the recording layer by the control of the objective lens by the first focus controller.

13. The optical recording medium drive device according to claim 12, wherein the spherical aberration correcting element and the magnification conversion element are each made of a Keplerian expander lens formed by two correcting lenses whose optical axes are the same, and one of the two correcting lenses is movable in an optical axis direction.

14. An optical recording medium drive device for optically recording information in accordance with a guide track to a recording layer of a separated guide layer type optical recording medium in which a guide layer having the guide track formed thereon and the recording layer are layered so as to be spaced apart from each other, comprising:
a first light source which generates a first laser beam for recording;
a second light source which generates a second laser beam for guiding;
a combining prism which combines the first laser beam with the second laser beam so as to coaxially guide the combined beams;
an objective lens which condenses the respective first and second laser beams from the combining prism toward the optical recording medium;
a first photodetecting unit which detects reflected light of the first laser beam from the recording layer;
a second photodetecting unit which detects reflected light of the second laser beam from the guide layer;
a magnification conversion element disposed on an optical path of the second laser beam between the second light source and the combining prism, which diffuses or converging the second laser beam incident upon the objective lens;
a first focus error generating unit which generates a first focus error signal indicating an error between a condensed spot position of the first laser beam and the recording layer based on an output signal of the first photodetecting unit;
a second focus error generating unit which generates a second focus error signal indicating an error between a condensed spot position of the second laser beam and the guide layer based on an output signal of the second photodetecting unit;
a first focus controller which controls the objective lens in an optical axis direction thereof in accordance with the first focus error signal;
a second focus controller which controls a magnitude of the diffusion or convergence of the second laser beam by the magnification conversion element in accordance with the first focus error signal or the second focus error signal;
a tracking error generating unit which generates a tracking error signal indicating an error between the condensed spot position of the second laser beam and the guide track of the guide layer based on the output signal of the second photodetecting unit;
a tracking controller which drives and controls the objective lens in a direction vertical to the optical axis direction thereof in accordance with the tracking error signal;
a spherical aberration correcting element disposed on an optical path of the first laser beam between the first light source and the combining prism;
a spherical aberration controller which controls a correction state of a spherical aberration by the spherical aberration correcting element; and
a main controller,
wherein the main controller reads out recording medium information based on the output signal of the second photodetecting unit, when the first focus controller controls the objective lens in accordance with the second focus error signal so that a focal point of the second laser beam is positioned on the guide layer, the second focus controller controls the magnification conversion element so as to optimize a spherical aberration of the second laser beam, and the tracking controller controls the objective lens in accordance with the tracking error signal so that the condensed spot position of the second laser beam is positioned on the guide track of the guide layer, and
modulates the first laser beam to start recording to the recording layer based on the recording medium information, when the second focus controller controls the magnification conversion element so as to have a working distance suitable for recording to the recording layer by the first laser beam, the spherical aberration controller controls a focal point of the first laser beam to be positioned in a vicinity of on the recording layer, the first focus controller controls the objective lens in accordance with the first focus error signal, in place of the second focus error signal, so that the focal point of the first laser beam is positioned on the recording layer, and the second focus controller controls the magnification conversion element in accordance with the second focus error signal so that the focal point of the second laser beam is positioned on the guide layer.

15. The optical recording medium drive device according to claim 14, wherein the spherical aberration correcting element and the magnification conversion element are each made of a Keplerian expander lens formed by two correcting lenses whose optical axes are the same, and one of the two correcting lenses is movable in an optical axis direction.

16. A recording method of an optical recording medium drive device which includes, for optically recording information in accordance with a guide track to a recording layer of a separated guide layer type optical recording medium in which a guide layer having the guide track formed thereon and the recording layer are layered so as to be spaced apart from each other:
a first light source which generates a first laser beam for recording;
a second light source which generates a second laser beam for guiding;
a combining prism which combines the first laser beam with the second laser beam so as to coaxially guide the combined beams;
an objective lens which condenses the respective first and second laser beams from the combining prism toward the optical recording medium;
a first photodetecting unit which detects reflected light of the first laser beam from the recording layer;
a second photodetecting unit which detects reflected light of the second laser beam from the guide layer;
a magnification conversion element disposed on an optical path of the second laser beam between the second light source and the combining prism, which diffuses or converging the second laser beam incident upon the objective lens;
a first focus error generating unit which generates a first focus error signal indicating an error between a condensed spot position of the first laser beam and the recording layer based on an output signal of the first photodetecting unit;
a second focus error generating unit which generates a second focus error signal indicating an error between a condensed spot position of the second laser beam and the guide layer based on an output signal of the second photodetecting unit;
a first focus controller which controls the objective lens in an optical axis direction thereof in accordance with the first focus error signal;
a second focus controller which controls a magnitude of the diffusion or convergence of the second laser beam by the magnification conversion element in accordance with the second focus error signal;
a first tracking error generating unit which generates a first tracking error signal indicating an error between the condensed spot position of the first laser beam and the guide track of the guide layer based on the output signal of the first photodetecting unit;
a second tracking error generating unit which generates a second tracking error signal indicating an error between the condensed spot position of the second laser beam and the guide track of the guide layer based on the output signal of the second photodetecting unit;
a tracking controller which drives and controls the objective lens in a direction vertical to the optical axis direction thereof in accordance with the tracking error signal;
a spherical aberration correcting element disposed on an optical path of the first laser beam between the first light source and the combining prism; and
a spherical aberration controller which controls a correction state of a spherical aberration by the spherical aberration correcting element,
the method comprising:
a first step of controlling the spherical aberration correcting element by the spherical aberration controller so as to be in a correction state optimum for reproduction of the guide layer;
a second step of positioning a focal point of the first laser beam is positioned on the guide layer by the control of the objective lens by the first focus controllers in accordance with the first focus error signal;
a third step of controlling the objective lens by the tracking controller in accordance with the first tracking error signal so that the condensed spot position of the first laser beam is positioned on the guide track of the guide layer, and
a fourth step of reading out recording medium information based on the output signal of the first photodetecting unit after executing the first to third steps;
a fifth step of controlling the magnification conversion element by the second focus controller so that a focal point of the second laser beam is positioned on the guide layer;
a sixth step of controlling the magnification conversion element by the second focus controller in accordance with the second focus error signal so that the focal point of the second laser beam is positioned on the guide layer;
a seventh step of controlling the objective lens by the tracking controller in accordance with the tracking error signal so that the condensed spot position of the second laser beam is positioned on the guide track of the guide layer;
an eighth step of jumping the focal point of the first laser beam to the recording layer by the control of the objective lens by the first focus controller; and
a ninth step of modulating the first laser beam to start recording to the recording layer based on the recording medium information after executing the fifth to eighth steps.

17. A recording method of an optical recording medium drive device which includes, for optically recording information in accordance with a guide track to a recording layer of a separated guide layer type optical recording medium in which a guide layer having the guide track formed thereon and the recording layer are layered so as to be spaced apart from each other:
a first light source which generates a first laser beam for recording;
a second light source which generates a second laser beam for guiding;
a combining prism which combines the first laser beam with the second laser beam so as to coaxially guide the combined beams;
an objective lens which condenses the respective first and second laser beams from the combining prism toward the optical recording medium;
a first photodetecting unit which detects reflected light of the first laser beam from the recording layer;
a second photodetecting unit which detects reflected light of the second laser beam from the guide layer;
a magnification conversion element disposed on an optical path of the second laser beam between the second light source and the combining prism, which diffuses or converging the second laser beam incident upon the objective lens;
a first focus error generating unit which generates a first focus error signal indicating an error between a condensed spot position of the first laser beam and the recording layer based on an output signal of the first photodetecting unit;
a second focus error generating unit which generates a second focus error signal indicating an error between a condensed spot position of the second laser beam and the guide layer based on an output signal of the second photodetecting unit;
a first focus controller which controls the objective lens in an optical axis direction thereof in accordance with the first focus error signal;
a second focus controller which controls a magnitude of the diffusion or convergence of the second laser beam by the magnification conversion element in accordance with the first focus error signal or the second focus error signal;
a tracking error generating unit which generates a tracking error signal indicating an error between the condensed spot position of the second laser beam and the guide track of the guide layer based on the output signal of the second photodetecting unit;
a tracking controller which drives and controls the objective lens in a direction vertical to the optical axis direction thereof in accordance with the tracking error signal;
a spherical aberration correcting element disposed on an optical path of the first laser beam between the first light source and the combining prism; and
a spherical aberration controller which controls a correction state of a spherical aberration by the spherical aberration correcting element,
the method comprising:
a first step of controlling the objective lens by the first focus controller in accordance with the second focus error signal so that a focal point of the second laser beam is positioned on the guide layer;
a second step of controlling the magnification conversion element by the second focus controller so as to optimize a spherical aberration of the second laser beam;
a third step of controlling the objective lens by the tracking controller in accordance with the tracking error signal so that the condensed spot position of the second laser beam is positioned on the guide track of the guide layer;
a fourth step of reading out recording medium information based on the output signal of the second photodetecting unit after executing the first to third steps;
a fifth step of controlling the magnification conversion element by the second focus controller so as to have a working distance suitable for recording to the recording layer by the first laser beam;
a sixth step of controlling a focal point of the first laser beam to be positioned in a vicinity of on the recording layer by the spherical aberration controller;
a seventh step of controlling the objective lens by the first focus controller in accordance with the first focus error signal, in place of the second focus error signal, so that the focal point of the first laser beam is positioned on the recording layer;
an eighth step of controlling the magnification conversion element by the second focus controller in accordance with the second focus error signal so that the focal point of the second laser beam is positioned on the guide layer; and
a ninth step of modulating the first laser beam to start recording to the recording layer based on the recording medium information after executing the sixth to eighth steps.
